(19) United States
(12) Patent Application Publication
(10) Pub. No.: US 2025/0067578 A1
(43) Pub. Date: Feb. 27, 2025

(54) ENCODER

(71) Applicant: MITUTOYO CORPORATION, Kawasaki (JP)

(72) Inventor: Toru Yaku, Kanagawa (JP)

(21) Appl. No.: 18/796,652

(22) Filed: Aug. 7, 2024

(30) Foreign Application Priority Data
Aug. 21, 2023 (JP) 2023-133983

(51) Int. Cl. G01D 5/20; G01B 7/30

(52) U.S. Cl. CPC G01D 5/20; G01B 7/30

(57) ABSTRACT

An encoder that can measure displacement with high accuracy by canceling out the effects of external noise is provided. The encoder includes a rotor, a stator and a calculation unit. The stator has an even number of detectors that read the graduations and output a signal. The calculation unit has a phase calculation unit that calculates the phase based on the signals output by the detectors, and an averaging unit that averages the phase calculated by the phase calculation unit. The even number of detectors are each located at a position displaced by an integer multiple of the period of the graduations along the measurement direction from the other adjacent detectors.

The first signal output by half of the detectors and the second signal output by the other half of the detectors to have opposite polarity at the input to the phase calculation unit.

### CROSS-REFERENCE TO RELATED APPLICATION

This non-provisional application claims priority under 35 U.S.C. § 119(a) from Japanese Patent Application No. 2023-133983, filed on Aug. 21, 2023, the entire contents of which are incorporated herein by reference.

### BACKGROUND OF THE INVENTION

### Field of the Invention

The present invention relates to encoders.

### Description of the Related Art

Conventional encoders are known to be equipped with a scale having graduations and a head that faces the scale and moves relative to the scale along the measurement direction. For example, an electromagnetic induction rotary encoder disclosed in JP 2006-322927A has a stator with a transmission winding and a reception winding corresponding to the head and a rotor with a magnetic flux coupling body corresponding to the scale. In this electromagnetic induction rotary encoder, a transmitting current that periodically changes the current direction is applied to the transmission winding. The magnetic flux coupling body generates an induced current based on the magnetic field generated by the transmission current flowing through the transmission winding. The reception winding detects the magnetic field generated by the induced current flowing through the magnetic flux coupling body and detects a signal corresponding to the intensity of the magnetic field.

With such encoders, noise can adversely affect detection performance.

In JP2020-193887A, the rotary encoder is disposed close to a motor or other device with a high current flow. Because the wiring for the motor and the wiring for the rotary encoder are often routed through the same wire duct, the high-frequency noise generated when the motor is driven is induced in the power lines of the rotary encoder. In position detection, if external noise is introduced into the power supply or high-frequency noise is introduced into the signal, the noise is superimposed on the detected signal and may cause errors in the position calculation. To address these problems, the rotary encoder of JP2020-193887A is equipped with noise-suppressing components that prevent noise from being superimposed on the detected signal. However, when the drive output of the motor is large, or when the feedback frequency is high to improve the responsive characteristics of the drive output, the high-frequency noise from the drive current is also large, and therefore the number of the noise suppressing components to be equipped must be increased.

In addition, high-frequency noise is induced in the analog circuits of the electrical components of the rotary encoder via the motor housing, drive shaft, rotary encoder housing, and the like. The rotary encoder in JP2020-134505A uses a low-pass filter to attenuate the high-frequency noise induced in the analog circuit. However, in this case, the detected signal is also attenuated along with noise, which may worsen accuracy and increase the flicker of angle detection data.

As a method to suppress noise superimposed on the detected signal without using noise-suppressing components and without attenuating noise along with the detected signal, JP2019-109093A discloses a method of canceling noise in a rotary encoder by arranging two detection sensors so that the phase difference of the output signals is 180° and averaging the position calculation results, which are the signals output from the two detection sensors.

### SUMMARY OF THE INVENTION

### Problems to be Solved by the Invention

However, in the rotary encoder of JP2019-109093A, the physical distance between the two detection sensors must be (integer+½) times the pitch of the graduations, making it difficult to achieve noise cancellation effects when the sensors are arranged at integer times the pitch. Therefore, rotary encoders have the problem that noise cancellation using two detection sensors to cancel noise may not be efficient due to physical limitations.

An object of the present invention is to provide an encoder that can measure displacement with high accuracy by canceling out the effects of external noise.

### Means for Solving the Problems

An encoder according to the present invention comprises: a scale with graduations arranged at predetermined period along the measurement direction; a head that is provided opposite the scale and moves relative to the scale along the measurement direction; and a calculation unit that calculates the relative displacement amount of the scale and head. The head has an even number of detectors that read the graduations and output a signal corresponding to the relative displacement amount of the scale and head. The calculation unit has a phase calculation unit that calculates the phase based on the signals output by the individual detectors and an averaging unit that averages the phase calculated by the phase calculation unit based on the signals output by the individual detectors. The even number of detectors are each located at a position that is displaced by an integer multiple of the graduation period along the measurement direction from the other adjacent detectors. The first signal output by half of the even number of detectors and the second signal output by the other half of the detectors to have opposite polarity at the input to the phase calculation unit.

According to the present invention, by configuring the first signal output by half of the even number of detectors and the second signal output by the other half of the detectors to have opposite polarity at the input to the phase calculation unit and by averaging the calculated phases, the effects of external noise superimposed on the signals can be canceled out. Therefore, even in environments where external noise is likely to occur, highly accurate displacement detection can be performed without the need for noise-suppressing components.

In this case, the encoder is preferably an electromagnetic inductive encoder, the scale has a scale coil as the graduation, and the head is preferably equipped with a transmission coil that generates a magnetic flux to the scale coil and a receiving coil that receives changes in the magnetic flux from the scale coils as detectors.

According to such a configuration, even if the encoder is an electromagnetic inductive encoder, the effect of external noise can be canceled without any noise-suppressing components, thus enabling highly accurate displacement detection even in environments where external noise is likely to occur.

In the electromagnetic inductive encoder as described above, the transmission current may be applied in the opposite direction to the transmission coils of half of the even number of detectors 43 and to the transmission coils of the remaining half of detectors.

According to such a configuration, the detectors can output signals so that the first signal output by half of the even number of detectors and the second signal output by the other half of the detectors have opposite polarity at the input to the phase calculation unit, and by averaging the calculated phases, which cancels out the effects of external noise. Therefore, the encoder can perform highly accurate displacement detection even in environments where external noise is likely to occur without the need for noise-suppressing components.

In the present invention, it is preferred that half of the detectors and the other half output signals of the same polarity according to the relative displacement amount of the scale and head, and that the polarity of the second signal is reversed from the first signal (i.e., the positive and negative of the signals are swapped) in the propagation path from the detectors to the input to the phase calculation unit in the calculation unit.

According to such a configuration, by configuring the first signal output by half of the even number of the detectors and the second signal output by the other half of the detectors to have opposite polarity at the input to the phase calculation unit, and by averaging the calculated phases, the calculation unit can cancel out the effects of external noise superimposed on the signals. Therefore, even in environments where external noise is likely to occur, highly accurate displacement detection can be performed without the need for noise-suppressing components.

### BRIEF DESCRIPTION OF THE DRAWINGS

FIG. 1 is a front view of the digital micrometer according to the first embodiment.

FIG. 2 is a schematic plan view of the rotor according to the first embodiment.

FIG. 3 is a schematic plan view of the stator according to the first embodiment.

FIG. 4 is a circuit block diagram showing the configuration of the calculation unit of the first embodiment.

FIGS. 5A and 5B illustrate the principle that errors occur in calculation results caused by external noise. Specifically, FIG. 5A shows an example of the waveform of a 2-phase signal at the input of the phase calculation unit 55. FIG. 5B shows the Lissajous waveform drawn by the 2-phase signal shown in FIG. 5A.

FIGS. 6A to 6D illustrate the principle of the cancellation of the external noise. Specifically, FIG. 6A shows an example of a waveform of the 2-phase signal obtained from the first signal S1 detected by the detectors of the first group. FIG. 6B shows an example of a waveform of the 2-phase signal obtained from the second signal S2 detected by the detectors of the second group. FIGS. 6C and 6D show the Lissajous waveforms drawn from the 2-phase signals shown in FIGS. 6A and 6B, respectively.

FIG. 7 is a schematic plan view of the stator and rotor according to the second embodiment.

FIG. 8 is a schematic diagram showing the calculation unit according to the second embodiment.

FIG. 9 is a schematic diagram showing the calculation unit according to a variation of the second embodiment.

### DETAILED DESCRIPTION OF THE EMBODIMENTS

### First Embodiment

A first embodiment of the present invention will be described below with reference to some accompanying drawings. In the following description, the same reference characters are given to identical members, and members that have already been described will not be described again as appropriate.

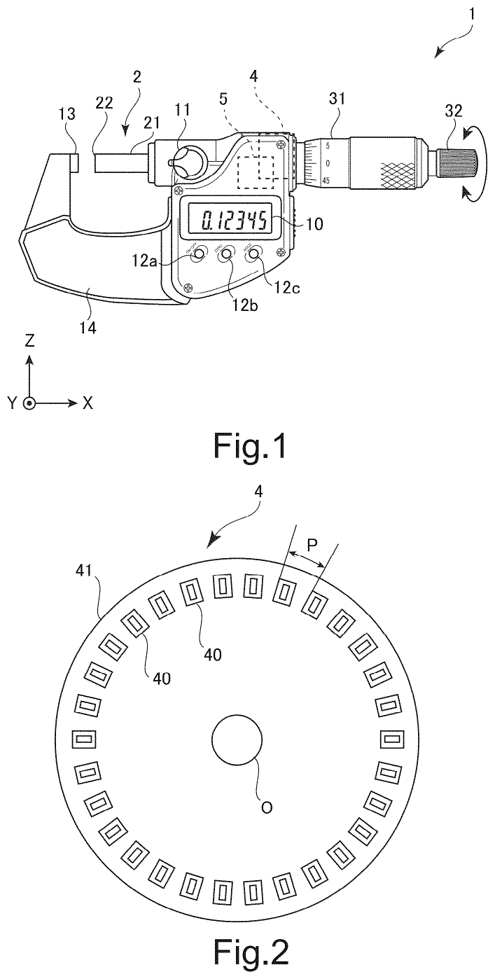

FIG. 1 shows a front view of a digital micrometer 1 that incorporates an encoder 4 according to the embodiment of the present invention. The encoder 4 is provided inside the digital micrometer 1 and detects the moving displacement amount of the measuring element 2.

As illustrated in FIG. 1, a digital micrometer 1 includes a measuring element 2 and encoder 4. The measuring element 2 has a cylindrical spindle 21 with a contact surface 22 at one end. The contact surface 22 is a surface at the end of spindle 21 for contacting the surface of the object to be measured.

The digital micrometer 1 includes a thimble 31 and a ratchet knob 32 as a mechanism for moving the measuring element 2. The digital micrometer 1 advances or retracts the spindle 21 against the object to be measured by rotating the thimble 31 or ratchet knob 32 in the direction of the arrow in the drawing with the spindle 21 as the axis.

The digital micrometer 1 is further provided with a clamp 11 for fixing the spindle 21, operating units 12a-12c for receiving operations from the user and making various settings for the digital micrometer 1, an anvil 13 and an arm 14.

The anvil 13 is the reference position in the digital micrometer 1 and is disposed opposite the contact surface 22 of the measuring element 2. The arm 14 is formed in generally U-shape. The measuring element 2 thimble 31, ratchet knob 32 and other components are located at one end of the arm 14. The anvil 13 is located at the other end of the arm 14. The digital micrometer 1 clamps the object to be measured between the contact surface 22 of the measuring element 2 and the anvil 13, and measures the length from the contact surface 22 to the anvil 13.

The results of the measurement by the digital micrometer 1, such as measurement values, are displayed on the display unit 10. The display unit 10 consists of an LCD panel and displays at least the measurement values. The display unit 10 mainly displays measurement value and other information on a 7-segment digital display.

FIG. 2 is a schematic plan view showing a configuration of the encoder 4 according to the present embodiment.

The encoder 4 is an electromagnetic induction type rotary encoder and includes a rotor 41, a stator 42 and a calculation unit 45. The encoder 4 detects the amount of moving displacement of the measuring element 2 from the reference position (e.g., the position where the contact surface 22 contacts the anvil 13).

As shown in FIG. 2, the rotor 41 has scale coils 40 as graduations arranged at a predetermined pattern period P along the measurement direction (circumferential direction). The rotor 41 is placed opposite the stator 42 so as to be rotatable around the rotation axis 0.

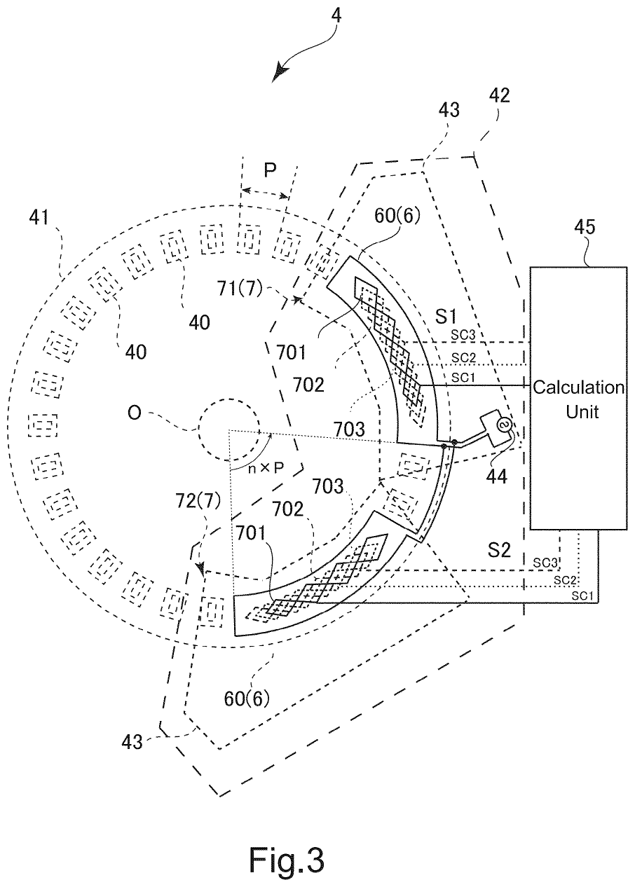

The stator 42 corresponds to the head and is provided opposite the rotor 41. As shown in FIG. 3, the stator 42 includes an even number of detectors 43 that detect the displacement amount (i.e., rotational displacement amount) of the rotor 41 relative to the stator 42 and output a signal corresponding to the displacement amount. Each detector 43 is located at a position displaced by n times the pattern period P of the scale coil 40 (n is a natural number greater than or equal to 1) from the adjacent detector 43 along the measurement direction. Owing to such an arrangement, each detector 43 detects a common phase in the periodic pattern of the scale coils 40.

Each detector 43 includes a transmission coil 6 and a receiving coil 7. An alternating transmission current is applied to the transmission coil 6 by the transmitter circuit 44. This transmission current causes the transmission coil 6 to generate an alternating magnetic field. In the rotor 41, the scale coil 40 opposite the transmission coil 6 generates a magnetic flux to cancel the alternating magnetic field generated by the transmission coil 6.

In this embodiment, the transmission current is applied in the opposite direction to the transmission coil 6 of half of the plurality of detectors 43 (hereinafter referred to as the first group) and to the transmission coil 6 of the remaining half of detectors 43 (hereinafter referred to as the second group). In other words, when the transmission current is flowing clockwise to the transmission coil 6 of the first group, the transmission current is flowing counterclockwise to the transmission coil 6 of the second group. With such a transmission current, in rotor 41, the scale coil 40 facing the transmission coil 6 of the first group and the scale coil 40 facing the transmission coil 6 of the second group generate magnetic fluxes in opposite directions. In the present embodiment, since two detectors 43 are provided, the first and second groups each have one detector 43.

The receiving coil 7 receives the change in magnetic flux generated by scale coil 40 as a signal corresponding to the position (displacement amount). The receiving coil 7 includes three receiving coil wires 70 to receive 3-phase signals from the magnetic flux generated by a transmitter coil wire 60. That is, the receiving coil wires 70 include a first receiving coil wire 701 that receives the 0° phase signal SC1, a second receiving coil wire 702 that receives the 1200 phase signal SC2, and a third receiving coil wire 703 that receives the 2400 phase signal SC3. In the following description, the signals SC1, SC2 and SC3 detected by the first group of receiving coils 7 may be referred to as a first signal S1 and the signals SC1, SC2 and SC3 detected by the second group of receiving coils 7 as a second signal S2.

As described above, in rotor 41, the scale coil 40 facing the transmission coil 6 of the first group and the scale coil 40 facing the transmission coil 6 of the second group generate magnetic fluxes in opposite directions. Thus, the first signal S1 detected by the first group of receiving coils 7 and the second signal S2 detected by the second group of receiving coils 7 are of opposite polarity. The first signal S1 and the second signal S2 are input to the calculation unit 45 and propagate in the calculation unit 45 so that they have opposite polarity at the input to the phase calculation unit 55.

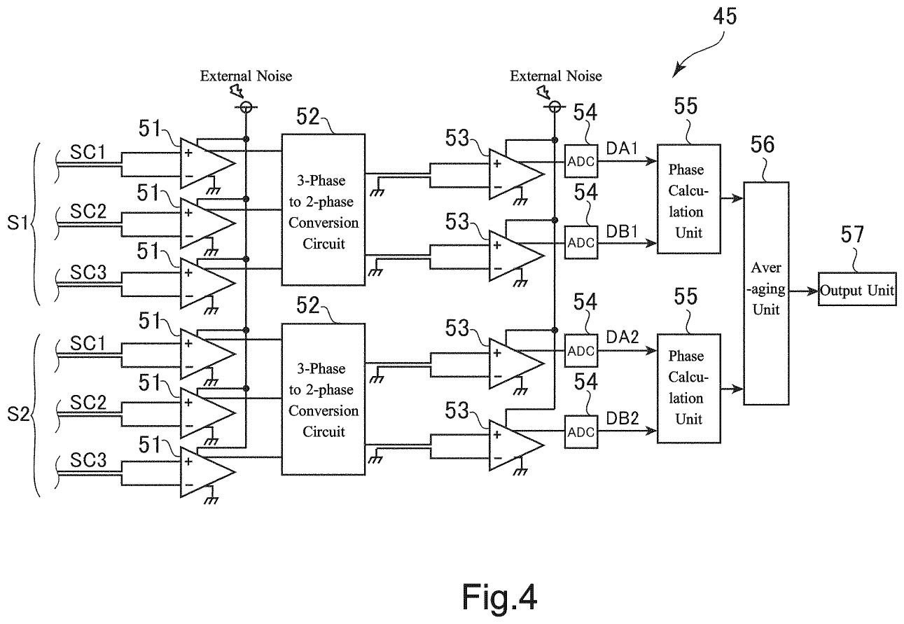

FIG. 4 is a circuit block diagram showing the configuration of the calculation unit 45 provided by encoder 4 in the present embodiment. As shown in FIG. 4, the calculation unit 45 includes a first amplifier 51, a 3-phase to 2-phase conversion circuit 52, a second amplifier 53, an A/D converter 54, a phase calculation unit 55, an averaging unit 56, and an output unit 57. Among these, the first amplifier 51, the 3-phase to 2-phase conversion circuit 52, the second amplifier 53, the A/D converter 54, and the phase calculation unit 55 are provided for each individual detector 43 independently. On the other hand, only one averaging unit 56 and one output unit 57 are provided in the calculation unit 45. The calculation unit 45 calculates the moving displacement amount of the measuring element 2 from the signals via the rotor 41 and stator 42. The rotor 41 is movable relative to the stator 42 along the measurement direction.

The first amplifier 51 receives the signals S1 and S2 detected by the detectors 43 and amplifies and outputs these signals. The first amplifier 51 is realized using, for example, an operational amplifier. The 3-phase to 2-phase conversion circuit 52 converts signals S1 and S2, which are 3-phase signals via the first amplifier 51, into analog 2-phase signals. The second amplifier 53 is an amplifier to which the signal converted to an analog 2-phase signal by the 3-phase to 2-phase conversion circuit 52 is input. The A/D converter 54 converts the analog 2-phase signal through the second amplifier 53 to a digital 2-phase signal. The phase calculation unit 55 calculates the phase from the digital 2-phase signal output by the A/D converter 54. As mentioned above, the first amplifier 51, the 3-phase to 2-phase conversion circuit 52, the second amplifier 53, the A/D converter 54, and the phase calculation unit 55 are provided for each individual detector 43 (i.e., for signals S1 and S2 respectively), so the phase calculated from signal S1 and phase calculated from signal S2 are obtained.

The averaging unit 56 calculates the average of the phases calculated by each phase calculation unit 55, and further calculates the displacement amount from the phase. The output unit 57 outputs the displacement amount calculated by the averaging unit 56 to, for example, a display unit 10 such as a monitor (see FIG. 1) or a data storage device such as a PC.

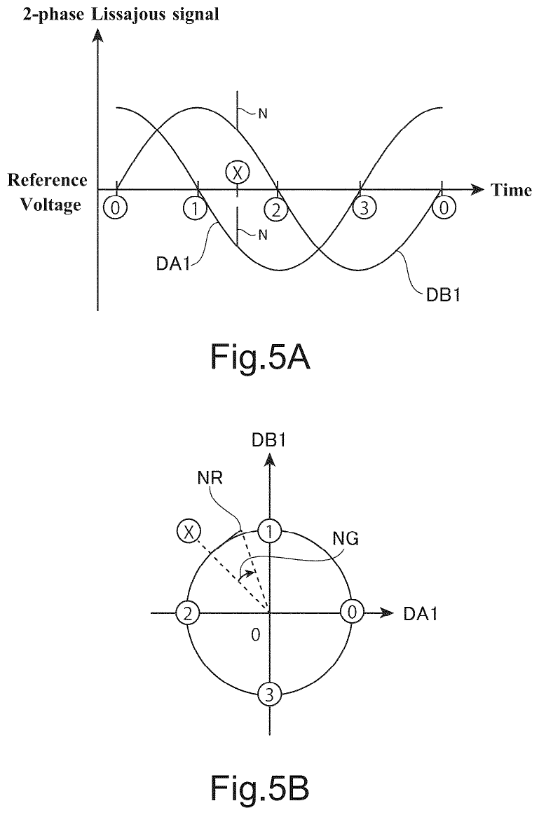

FIGS. 5A and 5B are graphs showing the principle that errors occur in calculation results of phase due to the external noise. Specifically, FIG. 5A shows an example of the waveform of a 2-phase signal at the input of the phase calculation unit 55 for the signal detected by the receiving coil 7. In FIG. 5A, the vertical axis is the amplitude of the signal (digital signal value) and the horizontal axis is time. FIG. 5B shows the Lissajous waveform drawn by the 2-phase signal shown in FIG. 5A. Numbers 0-3 on the time axis of the graph in FIG. 5A correspond to numbers 0-3 in the Lissajous waveform in FIG. 5B. The signals DA1 and DB1 shown in FIG. 5A are superimposed with external noise N at time X. Although this is not the case for micrometer 1 in the present embodiment, in an assembly configuration where a motor carrying a large current is installed near encoder 4, the wiring for the motor and the wiring for the encoder often pass through the same wire duct, and external noise N is easily superimposed on the signal that is detected by the receiving coil 7. This external noise N causes abrupt fluctuations in the waveform shown as NR in the Lissajous waveform shown in FIG. 5B, and causes an error NG in the phase calculated in the phase calculation unit 55.

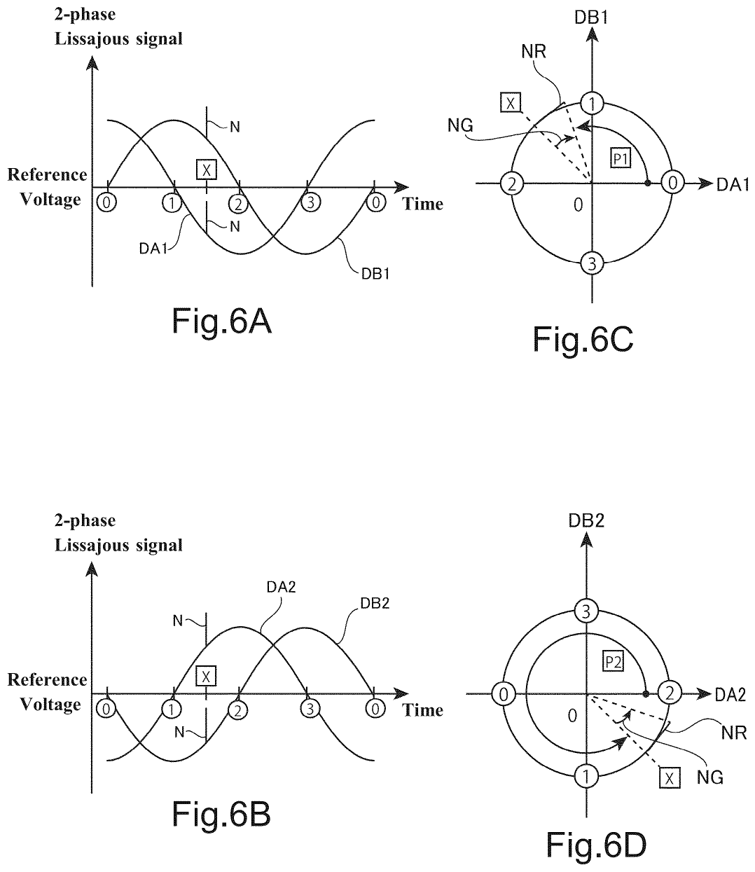

In the encoder 4 of the present embodiment, the error caused by the external noise N is cancelled out by averaging the phase calculated on the basis of the signals detected by each of the detectors 43. FIGS. 6A through 6D illustrate the principle that the error caused by external noise N is canceled by averaging.

FIG. 6A shows an example of a waveform of the 2-phase signal obtained from the first signal S1 detected by the detectors 43 of the first group. FIG. 6B shows an example of a waveform of the 2-phase signal obtained from the second signal S2 detected by the detectors 43 of the second group. In FIGS. 6A and 6B, the vertical axis is the amplitude of the 2-phase signal and the horizontal axis is time. FIGS. 6C and 6D show the Lissajous waveforms drawn from the 2-phase signals shown in FIGS. 6A and 6B, respectively. Numbers 0-3 on the time axis of the graph in FIGS. 6A and 6B correspond to numbers 0-3 in the Lissajous waveform in FIGS. 6C and 6D. The signals S1 and S2, which are the source of the Lissajous waveforms in FIGS. 6C and 6D, are opposite in polarity. Therefore, note that in the Lissajous waveforms of FIGS. 6C and 6D, the phases corresponding to the same time are 1800 offset from each other.

As shown in FIGS. 6A and 6B, each 2-phase signal are superimposed with external noise N at time X. When the Lissajous waveform is drawn based on the 2-phase signal with these noises N superimposed, as shown in FIGS. 6C and 6D, the external noise N causes variation NR in the Lissajous waveform and error NG in the calculated phase. Since the external noise N superimposed on the 2-phase signal at time X as shown in FIGS. 6A and 6B is of positively varying amplitude, the Lissajous waveform fluctuates to the upper right with the external noise N, as indicated by NR in FIGS. 6C and 6D. This variation of the Lissajous waveform caused by the external noise N becomes an error NG that delays the phase in the Lissajous waveform based on the signal S1 (FIG. 6C). On the other hand, in the Lissajous waveform based on signal S2 (FIG. 6D), the variation becomes an error NG that advances the phase. Since the phase calculated from signal S1 and the phase calculated from signal S2 have opposite effects on the phase, the error NG can be canceled and removed by averaging the phase calculated from signal S1 and the phase calculated from signal S2. This allows encoder 4 to calculate displacement amount with high accuracy by eliminating the effects of external noise.

According to such first embodiment, the following advantageous effects can be achieved:
(1) By configuring the first signal S1 output by half of the even number of detectors 43 and the second signal S2 output by the other half of the detectors 43 to have opposite polarity at the input to the phase calculation unit 55, and by averaging the calculated phases, the effects of external noise superimposed on the signals S1 and S2 can be canceled out. Therefore, encoder 4 can perform highly accurate displacement detection even in environments where external noise is likely to occur, without the need for noise-suppressing components.
(2) By merely configuring the current flowing to the transmission coil 6 in the first group of detectors 43 and the current flowing to the transmission coil 6 in the second group of detectors 43 to be in opposite directions and averaging the phase calculated based on the signals detected by the plurality of detectors 43, the effects of external noise can be canceled without making any other major changes to the configuration of the conventional encoder.

### Second Embodiment

The second embodiment of the present invention will be described below with reference to some accompanying drawings. In the following description, previously described parts are denoted by the same reference numbers and the descriptions thereof will be omitted.

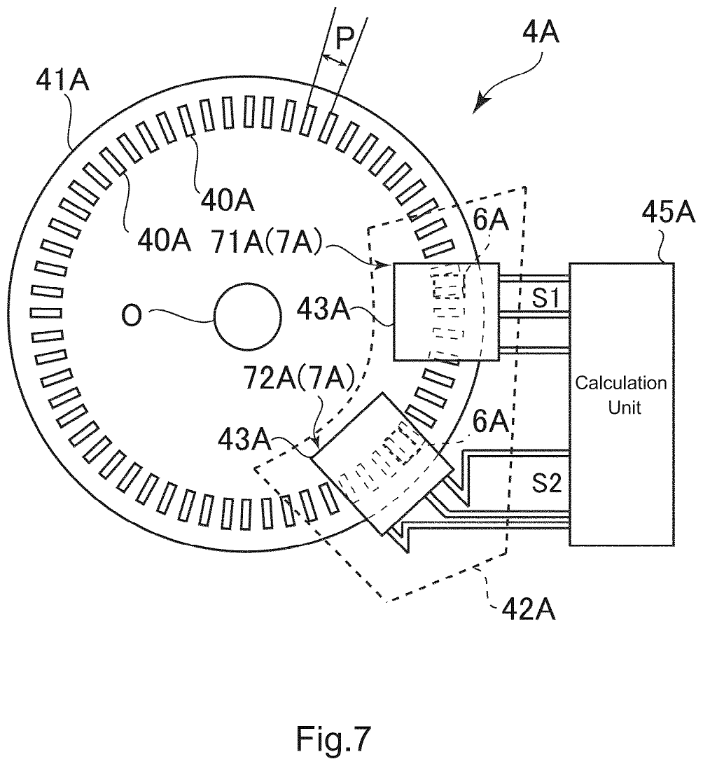

FIG. 7 is a schematic plan view of the stator and rotor in the encoder 4A according to the second embodiment. In the first embodiment, the encoder 4 was an electromagnetic induction rotary encoder, but in the second embodiment, encoder 4A differs from the first embodiment in that it is an optical rotary encoder. As shown in FIG. 7, the rotor 41A and stator 42A in encoder 4A have a configuration similar to that of a conventional optical rotary encoder. That is, the rotor 41A constitutes a scale with graduations 40A circularly engraved on its surface at a predetermined period P. The stator 42A includes an even number of detectors 43A.

Each detector 43A is located at a position displaced by n times the period P of the graduations 40A (n is a natural number greater than or equal to 1) from the adjacent detector 43A along the measurement direction. Owing to such an arrangement, each detector 43A detects a common phase in the periodic pattern of the graduations 40A. Half of the detectors 43A and the other half (i.e. all detectors 43A) output signals of the same polarity according to the relative displacement amount of the scale and head.

Each detector 43A includes a light source 6A that irradiates light onto the graduations 40A and a light receiving unit 7A that receives light through the graduations 40A and outputs a signal corresponding to the position (displacement). The signal output by the light receiving unit 7A is input to calculation unit 45A.

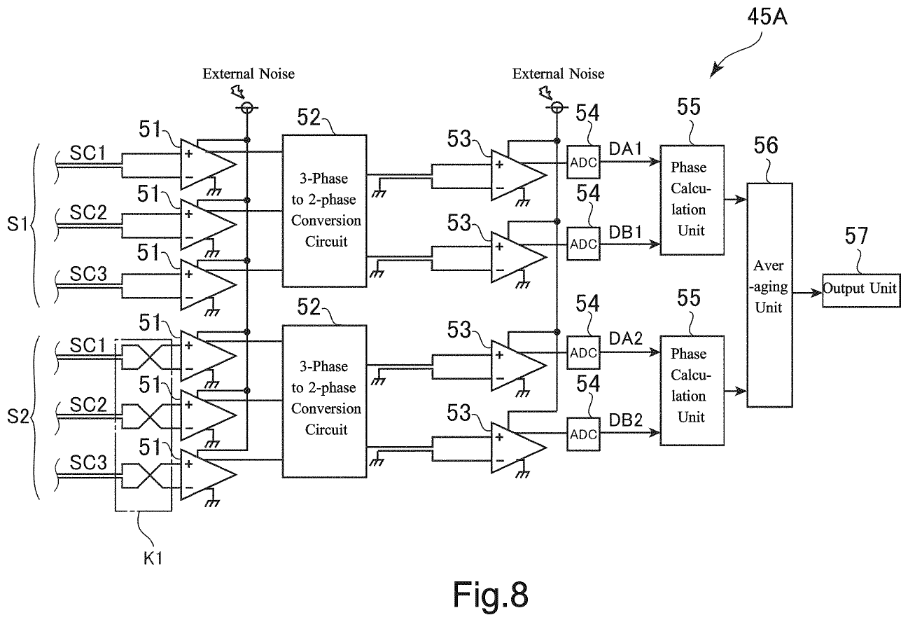

FIG. 8 is a schematic diagram showing the calculation unit 45A according to the second embodiment. As shown in FIG. 8, the calculation unit 45A has a configuration similar to that of the calculation unit 45 of the first embodiment shown in FIG. 4. As shown in FIG. 8, in calculation unit 45A, the signal S1 from half of the even number of detectors 43A is input to the first amplifier 51 without any particular processing. On the other hand, for the signal S2 from the other half of the even number of detectors 43A, the signal polarity is reversed (positive and negative are swapped) as indicated by K1 in FIG. 8 and input to the first amplifier 51. In this way, the signal S1 from the first group of detectors 43A and the signal S2 from the second group of detectors 43A propagate in the calculation unit 45A so that they have opposite polarity at the input to the phase calculation unit 55. As a result, as in the first embodiment, even if external noise is superimposed on the signal, the effect of the external noise can be removed by averaging the phase calculated by the phase calculation unit 55. Therefore, the encoder 4A can calculate the displacement amount with high accuracy even in environments where external noise is likely to occur.

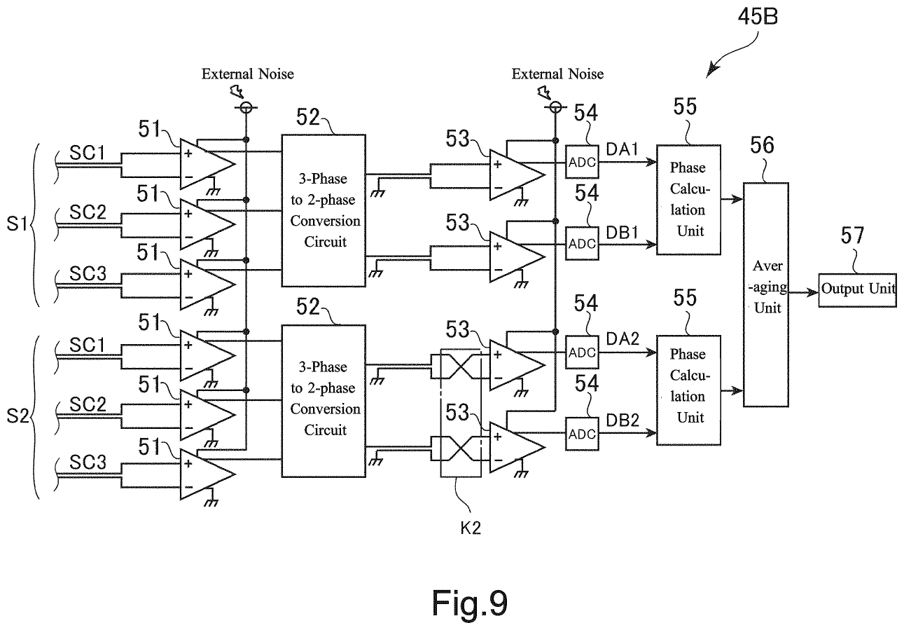

FIG. 9 is a schematic diagram showing the calculation unit 45B according to a variation of the second embodiment. This calculation unit 45B can be replaced with the calculation unit 45A of the second embodiment. In calculation unit 45A (see FIG. 8), the polarity of signal S2 from the detectors 43A of the second group was reversed compared to the signal from the first group at the input of the first amplifier 51, as shown in K1 in FIG. 8. However, the position where the polarity of the signal is reversed may not be at the input of the first amplifier 51, but between the 3-phase to 2-phase conversion circuit 52 and the second amplifier 53, as shown in K2 in FIG. 9. In this case, calculation unit 45B converts the signal S2 from the detectors 43A of the second group into a 2-phase signal at the 3-phase to 2-phase conversion circuit 52 with the same polarity as the signal S1 from the detectors 43A of the first group, and inputs the signal to the second amplifier 53. The converted 2-phase signal is input to the second amplifier 53 with the polarity reversed, as the positive and negative are swapped. In this way, the signal S1 from the first group of detectors 43A and the signal S2 from the second group of detectors 43A propagate in the calculation unit 45B so that they have opposite polarity at the input to the phase calculation unit 55. As a result, even in this variation, even if external noise is superimposed on the signal, the effect of the external noise can be removed by averaging the phase calculated by the phase calculation unit 55. Therefore, the encoder 4A can calculate the displacement amount with high accuracy even in environments where external noise is likely to occur. The position at which the polarity of the signals is swapped may be other than the position shown in the above second embodiment and its variation, as long as it is configured to reverse the polarity of the second signal with the first signal (i.e., to swap the positive and negative of the signals) in the propagation path from the detectors to the input to the phase calculation unit in the calculation unit.

In such a present embodiment, the same advantageous effects as those of (1) in the above-described first embodiment can be achieved.

### Variation of Embodiments

It should be noted that the present invention is not limited to the above-described respective embodiments, and any variation, improvement, or the like, is included in the present invention to the extent that the object of the present invention can be achieved. For example, in each of the above embodiments, the instrument in which the encoder 4, 4A is employed is the digital micrometer 1, but it can be any other measuring instrument such as an indicator, caliper, etc., or any other instrument other than a measuring instrument. In the embodiments described above, the optical encoder 4, 4A was a rotary encoder, but may be a linear encoder. In the second embodiment, encoder 4A was an optical type, but any type such as electromagnetic inductive, magnetic, or capacitance type can be employed.

n the above-described respective embodiments, the receiving coil 7 and light receiving unit 7A detected 3-phase signals, but the signals they detect may be 2-phase or 4-phase signals instead of 3-phase signals. The calculation unit 45, 45A in the above embodiments had the 3-phase to 2-phase conversion circuit 52, but a 4-phase to 2-phase conversion circuit 52 may be provided when dealing with 4-phase signals, or a conversion circuit may not be provided when dealing with 2-phase signals.

In the above-described respective embodiments, the rotor corresponding to the scale moved with respect to the stator corresponding to the fixed head, but the head may move with respect to the fixed scale. In other words, one of the scale and head may be movable relative to the other along the measurement direction. In the case of linear encoders, etc., the configuration in which the head moves with respect to a fixed scale is popular.

Any additions, deletions, and design modifications of constituent elements in the embodiments that those skilled in the art could conceive of and any combinations of features of the embodiments can also fall within the scope of the present invention as long as they contain the spirit of the present invention.

### INDUSTRIAL APPLICABILITY

As described above, the present invention can be suitably used for encoders used in noisy environments.

What is claimed is:

1. An encoder comprising:
a scale with graduations arranged at predetermined period along the measurement direction;
a head that is provided opposite the scale and moves relative to the scale along the measurement direction; and
a calculation unit that calculates the relative displacement amount of the scale and head,
wherein the head includes an even number of detectors that reads the graduations and outputs a signal corresponding to the relative displacement amount between the scale and the head,
the calculation unit includes:
a phase calculation unit that calculates the phase based on the signals output by the individual detectors; and
an averaging unit that averages the phase calculated by the phase calculation unit based on the signals output by the individual detectors, and
wherein the even number of detectors are each located at a position that is displaced by an integer multiple of the graduation period along the measurement direction from the other adjacent detectors, and
wherein the first signal output by half of the even number of detectors and the second signal output by the other half of the detectors to have opposite polarity at the input to the phase calculation unit.

2. The encoder according to claim 1, wherein the encoder is an electromagnetic inductive encoder,
scale includes a scale coil as the graduation, and
the head includes a transmission coil that generates a magnetic flux to the scale coils and a receiving coil that receives changes in the magnetic flux from the scale coils as detectors.

3. The encoder according to claim 2, wherein the transmission current is applied in the opposite direction to the transmission coils of half of the even number of detectors and to the transmission coils of the remaining half of detectors.

4. The encoder according to claim 1, wherein half of the detectors and the other half of the detectors output signals of the same polarity according to the relative displacement amount of the scale and head, and
the polarity of the second signal is reversed from the first signal in the propagation path from the detectors to the input to the phase calculation unit in the calculation unit.
